(19) United States
(12) Patent Application Publication
(10) Pub. No.: US 2009/0307415 A1
(43) Pub. Date: Dec. 10, 2009

(54) Memory device having multi-layer structure and driving method thereof

(76) Inventors: Yong-Hoon Kang, Suwon-si (KR); Ki Tae Park, Seongnami-si (KR)

Correspondence Address: HARNESS, DICKEY & PIERCE, P.L.C., P.O. BOX 8910, RESTON, VA, 20195, US

(21) Appl. No.: 12/457,238

(22) Filed: Jun. 4, 2009

(30) Foreign Application Priority Data
Jun. 5, 2008 (KR) 10-2008-0053015
Oct. 16, 2008 (KR) 10-2008-0101465

(51) Int. Cl. G06F 12/02; G06F 13/00

(52) U.S. Cl. 711/103; 710/301; 711/E12.008

(57) ABSTRACT

A memory device having a multi-layer structure, the memory device includes a first semiconductor layer including at least one memory cell array. The memory cell array includes a plurality of memory cells. A second semiconductor layer is on the first semiconductor layer. The second semiconductor layer includes a bit line and a page buffer connected to the bit line corresponding to the memory cell array. The memory device also includes a contact between the first semiconductor substrate and the second semiconductor substrate to connect the page buffer with the memory cell array.

### PRIORITY STATEMENT

This application claims priority under 35 U.S.C. §119 to Korean Patent Application Nos. 10-2008-0053015 filed on Jun. 5, 2008 and 10-2008-0101465 filed on Oct. 16, 2008, in the Korean Intellectual Property Office (KIPO), the entire contents of which is incorporated herein by reference.

### BACKGROUND

1. Field

The present invention relates to a memory device having a multi-layer structure and driving method thereof, and more particularly, to a memory device having a multi-layer structure, in which a memory cell array and a page buffer are disposed on different semiconductor substrates, and a driving method thereof.

2. Description of the Related Art

Flash memory is a non-volatile memory device which can maintain information stored therein regardless of the supply of power and the stored information can be electrically changed easily and quickly unlike another non-volatile memory device, read-only memory (ROM). Flash memory may be divided into a NOR type and a NAND type depending on the way that memory cells are connected with a bit line and a source line.

NAND flash memory (hereinafter, referred to as NAND flash) has a structure in which memory cells are connected in series between a bit line and a common source line. In other words, a cell array of NAND flash includes a plurality of memory cell arrays each including a plurality of memory cells connected in series. Due to the serial connection, NAND flash can have a higher degree of integration than any other existing types of semiconductor devices. In addition, NAND flash can simultaneously change information stored in a plurality of memory cells, so that it may provide faster updating than NOR flash.

For NAND flash, however, a page buffer and a memory cell array are formed on the same plane and in order to increase the degree of integration of the memory cell array, a single page buffer is shared by as many bit lines as possible. As a result, programming or reading may be restricted by the resistor and capacitor components of a bit line. Although approaches of using an additional page buffer have been used in order to solve the problem, the approaches increase the size of NAND flash and decrease the degree of integration of a memory cell array.

### SUMMARY

Example embodiments provide a memory device having a multi-layer structure which can increase the degree of integration and operation reliability.

Example embodiments also provide a method of driving a memory device having a multi-layer structure.

According an example embodiment, a memory device having a multi-layer structure includes a first semiconductor layer having a memory cell array including a plurality of memory cells. A second semiconductor layer which is on the first semiconductor layer. The second semiconductor layer includes a bit line and a page buffer connected with the bit line corresponding to the memory cell array, and a bit line contact between the first semiconductor layer and the second semiconductor layer to electrically connect the page buffer with the memory cell array.

According to an example embodiment, a memory device having a multi-layer structure includes a first semiconductor layer including a plurality of memory cell arrays each including a plurality of memory cells. A second semiconductor layer is on the first semiconductor layer. The second semiconductor layer includes a bit line and a page buffer connected with the bit line corresponding to the plurality of memory cell arrays. The memory device further includes a sub-bit line between the first semiconductor layer and the second semiconductor layer, and a contact between the first semiconductor layer and the second semiconductor layer to electrically connect the page buffer with the pair of memory cell arrays.

According to an example embodiment, a method of driving a memory device having a multi-layer structure includes operating a first page buffer in response to a first control signal output from a controller to communicate first data with a first memory cell array and operating a second page buffer in response to a second control signal output from the controller to communicate second data with a second memory cell array. The second page buffer starts to operate and communicates the second data with the second memory cell array at the same time the first page buffer starts to operate and communicates the first data with the first memory cell array or after the first page buffer starts to operate.

According to an example embodiment, a method of driving a memory device having a multi-layer structure includes operating a first page buffer in response to a first control signal output from a controller to communicate first data with a first memory cell array. Operating a second page buffer in response to a second control signal output from the controller to store a second data received through the bit line while the first page buffer is communicating the first data with the first memory cell array. Operating the second page buffer in response to a third control signal output from the controller to transmit the second data to the first page buffer through the bit line when the first page buffer completes communicating the first data with the first memory cell array.

### BRIEF DESCRIPTION OF THE DRAWINGS

Example embodiments will be more clearly understood from the following brief description taken in conjunction with the accompanying drawings. FIGS. 1-9J represent non-limiting, example embodiments as described herein.

FIG. 1 is a diagram of a memory device having a multi-layer structure according to example embodiments;

FIG. 2A is a circuit diagram of one of a plurality of memory cell arrays illustrated in FIG. 1;

FIG. 2B is a block diagram of one of a plurality of page buffers illustrated in FIG. 1;

FIG. 3 is a cross sectional view of the memory device illustrated in FIG. 1;

FIG. 4 is a cross sectional view of a memory device having a multi-layer structure according to example embodiments;

FIG. 5 is a block diagram of the memory device illustrated in FIGS. 1 through 3 or the memory device illustrated in FIG. 4;

FIG. 6 is a flowchart of a method of driving a memory device according to example embodiments;

FIG. 7 is a flowchart of a method of driving a memory device according to example embodiments;

FIG. 8 is a block diagram of an electronic system including a memory device having a multi-layer structure according to example embodiments; and

FIGS. 9A through 9J illustrate various examples of an electronic system including a memory device according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will be described more fully hereinafter with reference to the accompanying drawings, in which example embodiments are shown. Example embodiments may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

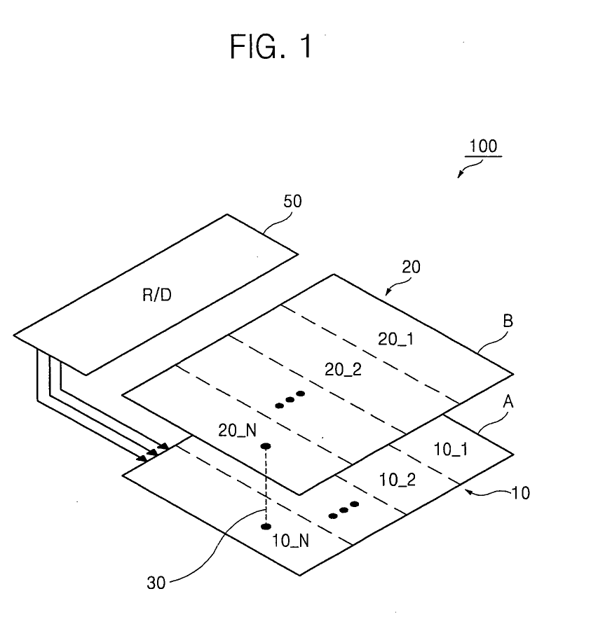

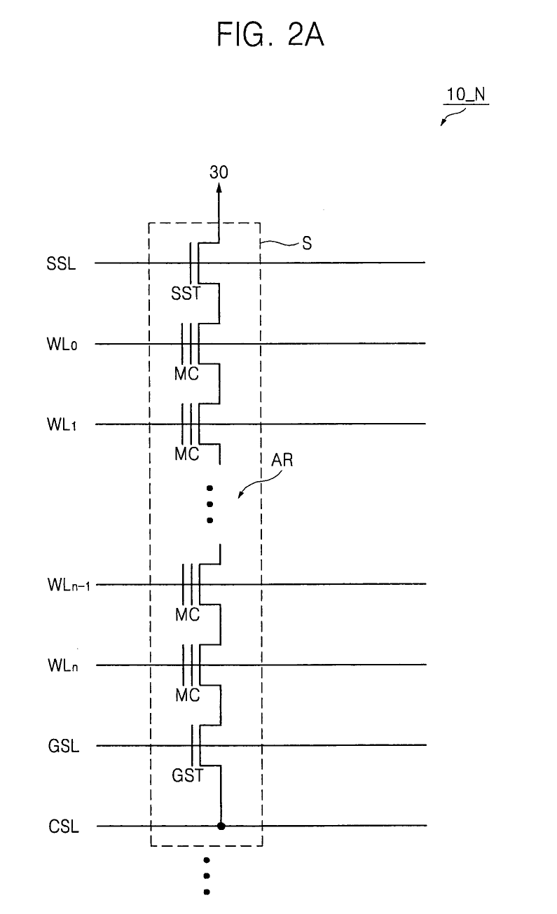

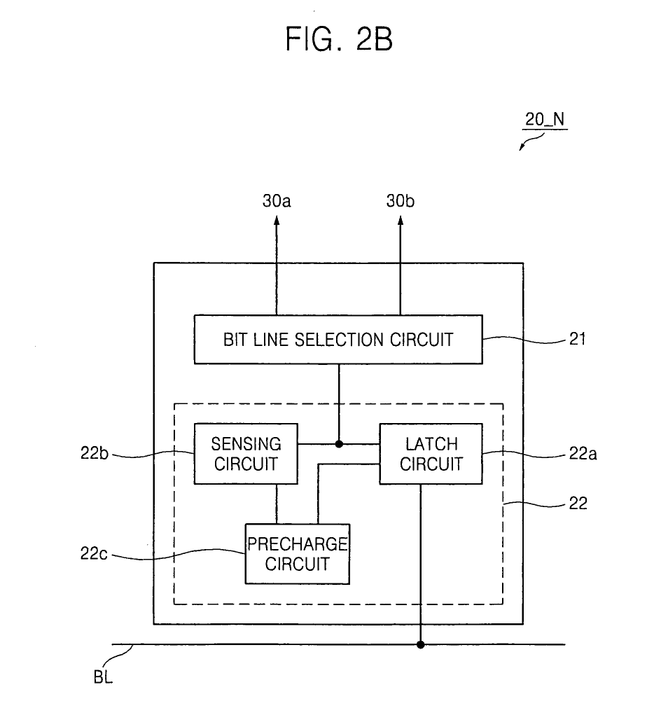

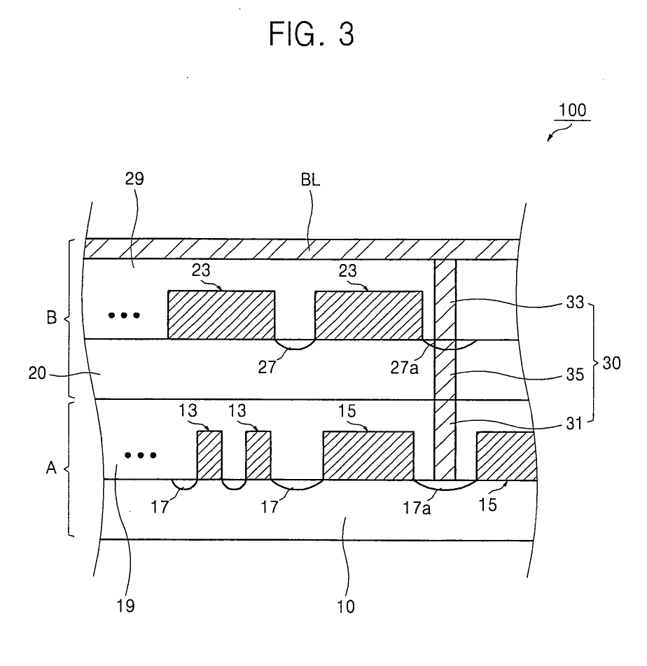

FIG. 1 is a diagram of a memory device 100 having a multi-layer structure according to an example embodiment. FIG. 2A is a circuit diagram of one of a plurality of memory cell arrays 10_1, 10_2, . . . , and 10_N illustrated in FIG. 1. FIG. 2B is a block diagram of one of a plurality of page buffers 10_1, 20_2, . . . , and 20_N illustrated in FIG. 1. FIG. 3 is a cross sectional view of a portion of the memory device 100 illustrated in FIG. 1.

Referring to FIGS. 1 through 3, the memory device 100 may have a structure in which a memory area A including the memory cell arrays 10_1 through 10_N and a page buffer area B including the page buffers 20_1 through 20_N may be on different semiconductor substrates 10 and 20, where the memory cell arrays 10_1 through 10_N correspond to the page buffers 20_1 through 20_N. The memory cell arrays 10_1 through 10_N may be on the first semiconductor substrate 10 of the memory area A. Each of the memory cell arrays 10_1 through 10_N may be connected with a one of the page buffers 20_1 through 20_N on the second semiconductor substrate 20 of the page buffer area B through a connecting element, e.g., a bit line contact 30 described later.

FIG. 2A illustrates only one memory cell array 10_N among the memory cell arrays 10_1 through 10_N illustrated in FIG. 1. The other memory cell arrays 10_1 and 10_2 have the same structure as the memory cell array 10_N illustrated in FIG. 2A. Referring to FIG. 2A, the memory cell array 10_N may include a plurality of memory cells MC each implemented by, for example, a memory cell transistor. The memory cells MC may be connected with a row decoder 50 through a plurality of word lines WL0, WL1, . . . , WLn-1, and WLn, respectively. The memory cell array 10_N may also include an active region AR and a string selection line SSL, a ground selection line GSL, and a common source line CSL perpendicular to the active region AR.

The word lines WL0 through WLn may be between the string selection line SSL and the ground selection line GSL. The memory cells MC connected with the word lines WL0 through WLn may be in the active region AR. A string selection transistor SST connected with the string selection line SSL and a ground selection transistor GST connected with the ground selection line GSL may also be in the active region AR.

The string selection transistor SST, the memory cells MC, and the ground selection transistor GST may be connected in series, forming a single string S. A drain of the string selection transistor SST of the string S may be connected with a bit line BL in the page buffer area B, which will be described later. A source of the ground selection transistor GST may be connected with the common source line CSL.

The page buffers 20_1 through 20_N may be on the second semiconductor substrate 20 of the page buffer area B to correspond to the memory cell arrays 10_1 through 10_N.

FIG. 2B illustrates only one page buffer 20_N among the page buffers 20_1 through 20_N illustrated in FIG. 1. The other page buffer 20_1 and 20_2 have the same structure as the page buffer 20_N illustrated in FIG. 2B. Referring to FIG. 2B, the page buffer 20_N may include a register circuit 22 and a bit line selection circuit 21. One end of the page buffer 20_N may be connected with the bit line BL and another end of the page buffer 20_N may be connected with the memory cell array 10_N in the memory area A illustrated in FIGS. 1 and 2A through a pair of connecting elements, e.g., a pair of bit line contacts 30a and 30b.

The register circuit 22 includes a precharge circuit 22c, a sensing circuit 22b, and a latch circuit 22a. The sensing circuit 22b may include a plurality of N-type metal-oxide semiconductor (NMOS) transistors (not shown). The register circuit 22 may also include a plurality of switches (not shown) and a reset circuit (not shown). The bit line selection circuit 21 may include a plurality of NMOS transistors (not shown).

During reading or programming, the bit line selection circuit 21 of the page buffer 20_N connects one of the bit line contacts 30a and 30b with a sensing node (not shown) of the sensing circuit 22b. The register circuit 22 senses read data from the bit line contact 30a or 30b connected with the sensing node and stores the read data. In addition, the register circuit 22 stores data which may be programmed to a memory cell array, e.g., the memory cell array 10_N illustrated in FIG. 2A, connected with the bit line contact 30a or 30b. In other words, read data may be transmitted to the register circuit 22 through the sensing node and data to be programmed may be transmitted to one of the bit line contacts 30a and 30b through the sensing node.

Referring back to FIGS. 1 and 2A, the row decoder 50 may be connected with the memory area A and transmit a signal to the word lines WL0 through WLn in each of the memory cell arrays 10_1 through 10_N.

Referring to FIGS. 1 through 3, the memory device 100 may have a structure in which the second semiconductor substrate 20 of the page buffer area B may be stacked on the first semiconductor substrate 10 of the memory area A. The first and second semiconductor substrates 10 and 20 may be made using at least one material selected from Si, Ge, SiGe, GaP, GaAs, SiC, SiGeC, InAs, and InP, but the present invention is not restricted thereto. In addition, a silicon-on-insulator (SOI) substrate may be used. A plurality of wells (not shown) may be formed on the first or second semiconductor substrate 10 or 20. The wells may improve the characteristics of transistors on the first or second semiconductor substrate 10 or 20. For instance, a pocket p-well may be on the first semiconductor substrate 10 and an n-well and a p-well may be on the second semiconductor substrate 20.

A plurality of gate structures, e.g., a plurality of first gate structures 13 and a plurality of second gate structures 15, may be on the first semiconductor substrate 10. The first gate structures 13 and the second gate structures 15 may be formed using, for example, photolithography. A first gate structure 13 may correspond to a gate structure of each of the memory cells MC illustrated in FIG. 2A and a second gate structure 15 may correspond to the string selection transistor SST or the ground selection transistor GST illustrated in FIG. 2A.

The first gate structures 13 and the second gate structures 15 may be formed by sequentially stacking a plurality of metal film patterns made of, for example, polysilicon, tungsten (W), titanium nitride (TiN), tantalum (Ta), tantalum nitride (TaN), or a combination thereof. The height of the first gate structures 13 may be substantially similar to that of the second gate structures 15. Example embodiments are not restricted thereto. When the first gate structures 13 and the second gate structures 15 have similar heights, end-point detection, e.g., detection of the height of the first gate structures 13 and the second gate structures 15, may be easy during chemical mechanical polishing (CMP) in a procedure of forming the first gate structures 13 and the second gate structures 15.

A plurality of first junction regions 17 may be formed on the first semiconductor substrate 10 exposed through the first gate structures 13 and the second gate structures 15. The plurality of first junction regions 17 may be formed by implanting impurities into an exposed portion of the first semiconductor substrate 10. The first gate structures 13 and the second gate structures 15 share the first junction regions 17 with each other. In other words, the string selection transistor SST, the memory cells MC, and the ground selection transistor GST illustrated in FIG. 2A are connected in series by way of sharing the first junction regions 17, thereby forming the string S.

The string S may be connected with the bit line BL in the page buffer area B through a first bit line junction region 17a among the first junction regions 17 and the bit line contact 30. In particular, second gate structures 15, e.g., string selection transistors SST, respectively included in two adjacent strings S may be formed to share a single first bit line junction region 17a with each other. An interlayer insulating film 19 may be formed on the first gate structures 13, the second gate structures 15, and the first junction regions 17. The interlayer insulating film 19 may be formed such that the first gate structures 13 and the second gate structures 15 can be covered therewith.

A first bit line contact 31 may be formed by etching a region in the interlayer insulating film 19, e.g., a region of the interlayer insulating film 19 corresponding to the first bit line junction region 17a among the first junction regions 17. In other words, the first bit line contact 31 may be formed by etching and removing a portion of the interlayer insulating film 19 formed on the first bit line junction region 17a and forming a via or plug using a conductive material to be connected with the first bit line junction region 17a. In other words, the first bit line contact 31 may be formed between the first bit line junction region 17a on the first semiconductor substrate 10 and the second semiconductor substrate 20.

As a result, the first semiconductor substrate 10 including the first gate structures 13, the second gate structures 15, the first junction regions 17, the first bit line junction region 17a, the interlayer insulating film 19, and the first bit line contact 31 may be completed. The second semiconductor substrate 20 may be stacked on and bonded to the first semiconductor substrate 10. The second semiconductor substrate 20 may be bonded to the first semiconductor substrate 10 using, for example, silicon bonding. On the second semiconductor substrate 20, the page buffer 20_N illustrated in FIG. 2B, which corresponds to a single string S including the first gate structures 13 and the second gate structures 15 on the first semiconductor substrate 10, that is, the memory cell array 10_N illustrated in FIG. 2A, may be formed.

A plurality of third gate structures 23 may be on the second semiconductor substrate 20. The third gate structures 23 may correspond to a plurality of driving transistors (not shown) included in the page buffer 20_N. The third gate structures 23 may be formed by sequentially stacking a plurality of metal film patterns made of, for example, polysilicon, tungsten (W), titanium nitride (TiN), tantalum (Ta), tantalum nitride (TaN), or a combination thereof.

A plurality of second junction regions 27 may be on the second semiconductor substrate 20 exposed through the third gate structures 23. The third gate structures 23 share the second junction regions 27 with each other. The second junction regions 27 may be in substantially the same as the first junction regions 17 on the first semiconductor substrate 10. In other words, the second junction regions 27 may be formed by implanting impurities into the second semiconductor substrate 20 exposed through the third gate structures 23.

A second bit line junction region 27a among the second junction regions 27 may be positioned on the second semiconductor substrate 20 to correspond to the first bit line junction region 17a on the first semiconductor substrate 10. The second bit line junction region 27a on the second semiconductor substrate 20 may be connected with the bit line BL through a bit line contact, e.g., a second bit line contact 33. An interlayer insulating film 29 may be on the third gate structures 23 and the second junction regions 27.

The second bit line contact 33 may be formed by etching and removing a region in the interlayer insulating film 29, e.g., a portion of the interlayer insulating film 29 formed on the second bit line junction region 27a, so as to be connected with the second bit line junction region 27a. The second bit line contact 33 may be a via or plug formed using a conductive material. In other words, the second bit line contact 33 may be formed on the second semiconductor substrate 20 between the bit line BL and the second bit line junction region 27a. The bit line BL connected with the second bit line contact 33 may be formed on the interlayer insulating film 29.

The first bit line contact 31 on the first semiconductor substrate 10 may be connected with the second bit line contact 33 through another bit line contact, e.g., a third bit line contact 35. The third bit line contact 35 may be in the second semiconductor substrate 20 between the first bit line contact 31 and the second bit line contact 33. In other words, one end of the third bit line contact 35 in the second semiconductor substrate 20 may be connected with one end of the first bit line contact 31 and the other end of the third bit line contact 35 may be connected with one end of the second bit line contact 33. Accordingly, the first bit line contact 31 may be connected with the second bit line contact 33 through the third bit line contact 35. The third bit line contact 35 may be a via formed in the second semiconductor substrate 20.

As a result, the second semiconductor substrate 20 including the third gate structures 23, the second junction regions 27, the interlayer insulating film 29, the second bit line contact 33, and the bit line BL may be completed. Thereafter, a plurality of processes, e.g., a process of wiring for input and output of electrical signals and a process of packaging semiconductor substrates, widely known to those skilled in the art of semiconductor devices, may be performed to complete the memory device 100 having a multi-layer structure.

Example embodiments show the memory device 100 may be formed by stacking a semiconductor substrate including the page buffers 20_1 through 20_N and the bit line BL on another semiconductor substrate including the memory cell arrays 10_1 through 10_N, thereby decreasing resistance and capacitance of the bit line BL driven by the page buffers 20_1 through 20_N and increasing efficiency of reading and programming of the memory cell arrays 10_1 through 10_N. In addition, since the page buffers 20_1 through 20_N and the memory cell arrays 10_1 through 10_N are formed on different semiconductor substrates, the degree of integration can be increased in the memory cell arrays 10_1 through 10_N.

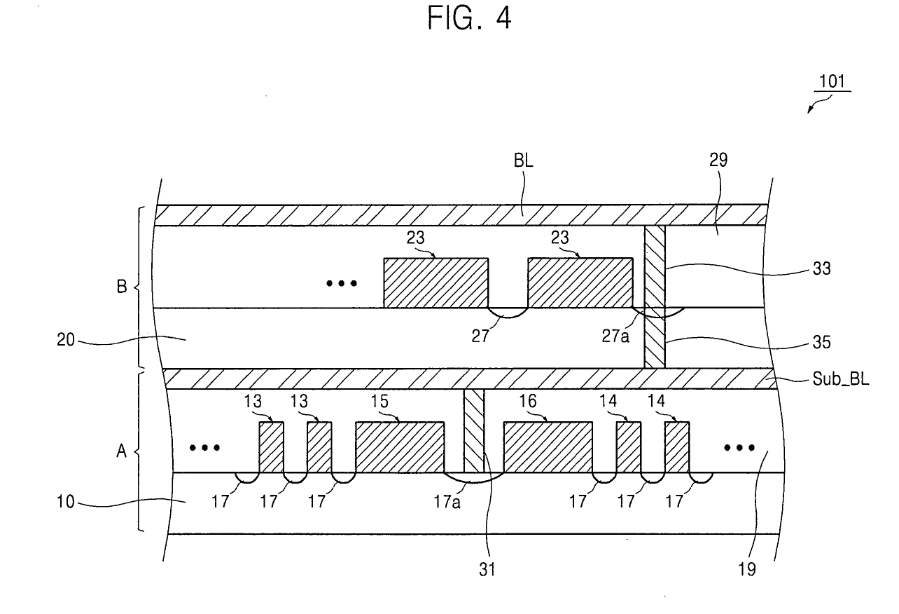

Hereinafter, a memory device having a multi-layer structure according to an example embodiment will be described with reference to FIG. 4. FIG. 4 is a cross sectional view of a memory device 101 having a multi-layer structure according to an example embodiment. The same elements as those illustrated in FIG. 3 are denoted by the same reference numerals and descriptions thereof will be omitted.

Referring to FIG. 4, the memory device 101 may be stacked on the first semiconductor substrate 10 of the memory area A and the second semiconductor substrate 20 of the page buffer area B. A plurality of gate structures, e.g., a plurality of first gate structures 13 and 14 and a plurality of second gate structures 15 and 16, may be two adjacent strings S on the first semiconductor substrate 10. In other words, the first gate structures 13 and 14 and the second gate structures 15 and 16 may be a pair of memory cell arrays sharing the first bit line junction region 17a may be on the first semiconductor substrate 10. Each of the first gate structures 13 and 14 may correspond to a gate structure of each of the memory cells MC illustrated in FIG. 2A. Each of the second gate structures 15 and 16 may correspond to the string selection transistor SST or the ground selection transistor GST illustrated in FIG. 2A.

A plurality of first junction regions 17 may be on the first semiconductor substrate 10 exposed through the first gate structures 13 and 14 and the second gate structures 15 and 16. The first junction regions 17 may be formed by implanting impurities into an exposed portion of the first semiconductor substrate 10. The first gate structures 13 and 14 and the second gate structures 15 and 16 share the first junction regions 17 with each other. In addition, the second gate structures 15 and 16, e.g., string selection transistors SST, of a pair of strings S may share a single first bit line junction region 17a with each other. The interlayer insulating film 19 may be on the first gate structures 13 and 14, the second gate structures 15 and 16, and the first junction regions 17 such that the first gate structures 13 and 14 and the second gate structures 15 and 16 are covered with the interlayer insulating film 19.

The first bit line contact 31 may be formed by etching a region in the interlayer insulating film 19, e.g., a region of the interlayer insulating film 19 corresponding to the first bit line junction region 17a among the first junction regions 17. In other words, the first bit line contact 31 may be formed by etching and removing a portion of the interlayer insulating film 19 formed on the first bit line junction region 17a and forming a via or plug using a conductive material to be connected with the first bit line junction region 17a. A sub-bit line Sub_BL connected with the first bit line contact 31 is formed on the interlayer insulating film 19. The sub-bit line Sub_BL may be connected with the first bit line junction region 17a through the first bit line contact 31.

The second semiconductor substrate 20 may be stacked on and bonded to the sub bit line Sub_BL of the first semiconductor substrate 10. The second semiconductor substrate 20 may be bonded to the sub-bit line Sub_BL using, for example, silicon bonding. On the second semiconductor substrate 20, a single page buffer corresponding to a pair of strings, i.e., a pair of memory cell arrays, including the first gate structures 13 and 14 and the second gate structures 15 and 16 on the first semiconductor substrate 10 may be formed.

A plurality of third gate structures 23 may be on the second semiconductor substrate 20. The third gate structures 23 may correspond to a plurality of driving transistors (not shown) included in a page buffer. A plurality of second junction regions 27 are on the second semiconductor substrate 20 exposed through the third gate structures 23. The third gate structures 23 share the second junction regions 27 with each other. The second junction regions 27 may be substantially the same as the first junction regions 17 on the first semiconductor substrate 10. The interlayer insulating film 29 is on the third gate structures 23 and the second junction regions 27.

The second bit line contact 33 may be formed by etching and removing a region in the interlayer insulating film 29, e.g., a portion of the interlayer insulating film 29 on the second bit line junction region 27a, so as to be connected with the second bit line junction region 27a. The second bit line contact 33 may be a via or plug of a conductive material. The bit line BL connected with the second bit line contact 33 may be on the interlayer insulating film 29.

The second bit line contact 33 may be connected with the sub bit line Sub_BL on the first semiconductor substrate 10 through another bit line contact, e.g., the third bit line contact 35. In other words, the third bit line contact 35 may be on the second semiconductor substrate 20 between the second bit line junction region 27a and the sub bit line Sub_BL and the sub bit line Sub_BL may be connected with the second bit line contact 33 through the third bit line contact 35. The third bit line contact 35 may be a via in the second semiconductor substrate 20. The second semiconductor substrate 20 includes the third gate structures 23, the second junction regions 27, the interlayer insulating film 29, the second bit line contact 33, and the bit lint BL.

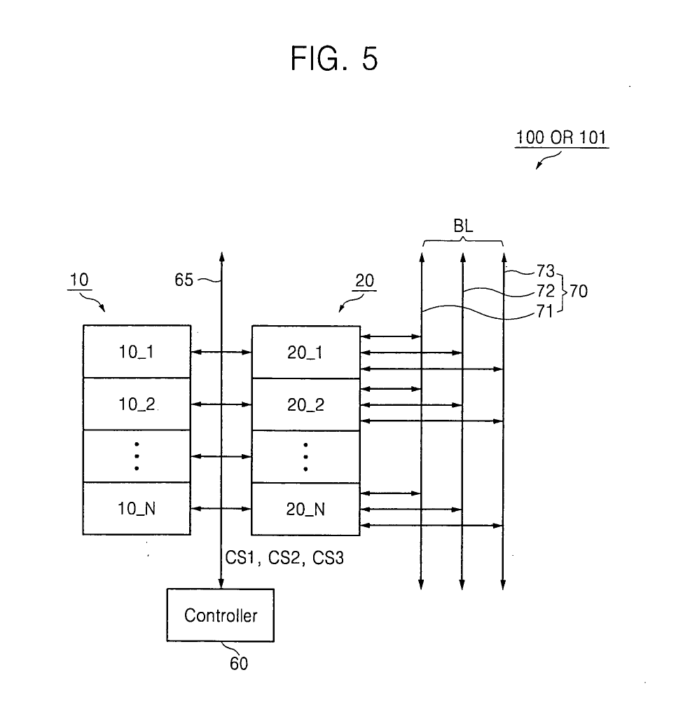

Although not shown in FIGS. 3 and 4, the memory device 100 or 101 having a multi-layer structure may also include a controller 60 illustrated in FIG. 5. The controller 60 may be connected with each of a plurality of page buffers on the second semiconductor substrate 20 and output a control signal to control the operation of each page buffer.

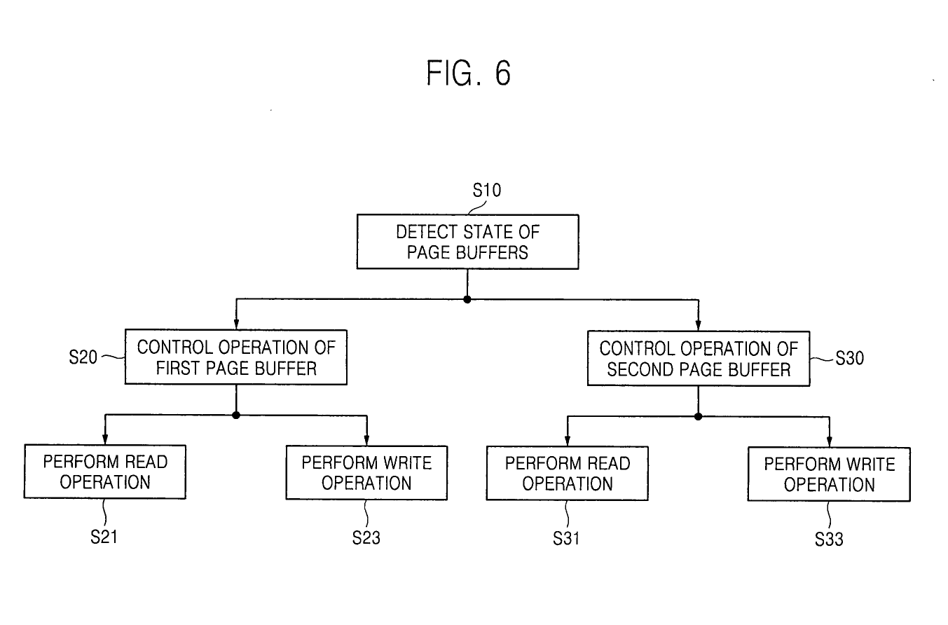

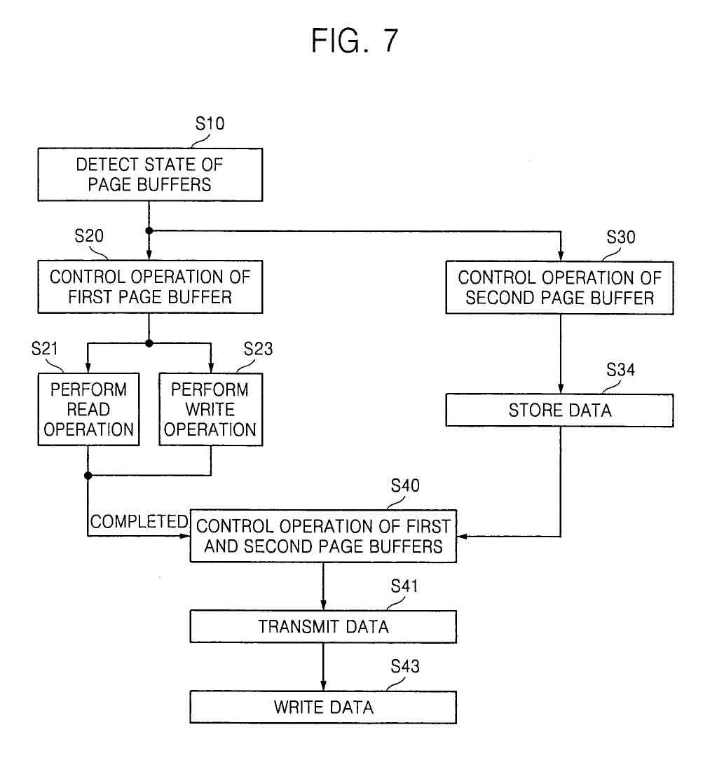

Hereinafter, a method of driving the memory device 100 or 101 according to some embodiments of the present invention will be described with reference to FIGS. 5 through 7. FIG. 5 is a block diagram of the memory device 100 illustrated in FIGS. 1 through 3 or the memory device 101 illustrated in FIG. 4. FIG. 6 is a flowchart of a method for driving the memory device 100 or 101 according to example embodiments. FIG. 7 is a flowchart of a method for driving the memory device 100 or 101 according to example embodiments.

Referring to FIG. 5, the memory device 100 or 101 may include the first semiconductor substrate 10, the second semiconductor substrate 20, the controller 60, and at least one bit line BL. As described above with reference to FIGS. 1 through 4, the memory cell arrays 10_1 through 10_N may be on the first semiconductor substrate 10 and the page buffers 20_1 through 20_N may be on the second semiconductor substrate 20. The memory cell arrays 10_1 through 10_N may be connected with the page buffers 20_1 through 20_N.

The controller 60 may output a control signal CS1, CS2 and CS3 to control the operation of each of the page buffers 20_1 through 20_N on the second semiconductor substrate 20. For instance, the controller 60 may be connected with each of the page buffers 20_1 through 20_N on the second semiconductor substrate 20 through at least one control line 65 and output the control signal CS1, CS2 and CS3 to each of the page buffers 20_1 through 20_N through the at least one control line 65 to independently control the operation of each of the page buffers 20_1 through 20_N. Accordingly, in response to the control signal CS1, CS2 and CS3 output from the controller 60, each of the page buffers 20_1 through 20_N may receive a data signal from the at least one bit line BL and output the data signal to a corresponding one of the memory cell arrays 10_1 through 10_N in a write operation or may read a data signal from one of the memory cell arrays 10_1 through 10_N in a read operation.

The at least one bit line BL may be connected with each of the page buffers 20_1 through 20_N. For example, the memory device 100 or 101 may include a first bit line 71, a second bit line 72, and a third bit line 73. The example embodiment is not restricted thereto. The first through third bit lines 71 through 73 may be connected with each of the page buffers 20_1 through 20_N and may provide a data signal, e.g., an input data signal, to each of the page buffers 20_1 through 20_N or may be provided with a data signal, e.g., an output data signal, from each of the page buffers 20_1 through 20_N according to the control signal CS1, CS2 and CS3 output from the controller 60.

Hereinafter, a method of driving the memory device 100 or 101 according to example embodiments will be described with reference to FIGS. 5 and 6. The controller 60 may detect the state of each of the page buffers 20_1 through 20_N in operation S10. For instance, the controller 60 may output a signal for detecting a current state to each of the page buffers 20_1 through 20_N and detect the current state of each of the page buffers 20_1 through 20_N from a response to the signal from each of the page buffers 20_1 through 20_N. In the example embodiment the method may proceed from an initial state of inactive for each of the page buffers 20_1 through 20_N.

The controller 60 may control an operation, e.g., a write or program operation or a read operation, of each of the page buffers 20_1 through 20_N through the control line 65 connected with the page buffers 20_1 through 20_N. For example, the controller 60 may output a first control signal CS1 to control an operation of the first page buffer 20_1 in operation S20. In addition, the controller 60 may output a second control signal CS2 to control an operation of the second page buffer 20_2 in operation S30. The first and second control signals CS1 and CS2 may be output from the controller 60 to the first and second page buffers 20_1 and 20_2, respectively, at the same time. Alternatively, the first control signal CS1 may be output to the first page buffer 20_1 and the second control signal CS2 may be output to the second page buffer 20_2 while the first page buffer 20_1 is operating in response to the first control signal CS1.

The first page buffer 20_1 may communicate a data signal with the first memory cell array 10_1 in response to the first control signal CS1 output from the controller 60. For example, the first page buffer 20_1 may receive a data signal from the first bit line 71 and write it to the first memory cell array 10_1 in response to the first control signal CS1 output from the controller 60 in operation S23. In addition, the first page buffer 20_1 may read a data signal from the first memory cell array 10_1 in response to the first control signal CS1 output from the controller 60 in operation S21. The read data signal may be transmitted through the first bit line 71.

The second page buffer 20_2 may communicate a data signal with the second memory cell array 10_2 in response to the second control signal CS2 output from the controller 60. For example, the second page buffer 20_2 may receive a data signal from the second bit line 72 and write it to the second memory cell array 10_2 in response to the second control signal CS2 output from the controller 60 in operation S33. In addition, the second page buffer 20_2 may read a data signal from the second memory cell array 10_2 in response to the second control signal CS2 output from the controller 60 in operation S31. The read data signal may be transmitted through the second bit line 72. As described above, the second page buffer 20_2 may perform the read or write operation in response to the second control signal CS2 at the same time when the first page buffer 20_1 performs the read or write operation or after the first page buffer 20_1 starts the read or write operation.

According to example embodiments, the operation of the first page buffer 20_1 and the operation of the second page buffer 20_2 are independently controlled using the control signal, e.g., the first and second control signals CS1 and CS2, output from the controller 60, so that the second memory cell array 10_2 can perform the read or write operation while the first memory cell array 10_1 performs the read or write operation. As a result, the operating performance of the memory device 100 or 101 may be improved.

Hereinafter, a method of driving the memory device 100 or 101 according to example embodiments will be described with reference to FIGS. 5 and 7. The controller 60 may detect the state of each of the page buffers 20_1 through 20_N in operation S10. For example, the controller 60 may output a signal for detecting a current state to each of the page buffers 20_1 through 20_N and detect the current state of each of the page buffers 20_1 through 20_N from a response to the signal from each of the page buffers 20_1 through 20_N. In the example embodiments the method may proceed from an initial state of inactive for each of the page buffers 20_1 through 20_N.

The controller 60 may control an operation, e.g., a write or program operation or a read operation, of each of the page buffers 20_1 through 20_N through the control line 65 connected with the page buffers 20_1 through 20_N. For example, the controller 60 may output a first control signal CS1 to control an operation of the first page buffer 20_1 in operation S20. In addition, the controller 60 may output a second control signal CS2 to control an operation of the second page buffer 20_2 in operation S30. The first and second control signals CS1 and CS2 may be output from the controller 60 to the first and second page buffers 20_1 and 20_2 at the same time. Alternatively, the first control signal CS1 may be output to the first page buffer 20_1 and the second control signal CS2 may be output to the second page buffer 20_2 while the first page buffer 20_1 is operating in response to the first control signal CS1.

The first page buffer 20_1 may communicate a data signal with the first memory cell array 10_1 in response to the first control signal CS1 output from the controller 60. For example, the first page buffer 20_1 may receive a data signal from the first bit line 71 and write it to the first memory cell array 10_in response to the first control signal CS1 output from the controller 60 in operation S23. In addition, the first page buffer 20_1 may read a data signal from the first memory cell array 10_1 in response to the first control signal CS1 output from the controller 60 in operation S21. The read data signal may be transmitted through the first bit line 71.

The second page buffer 20_2 may receive a data signal from the second bit line 72 and temporarily store it in operation S34. As described above, the second page buffer 20_2 may receive the data signal from the second bit line 72 and temporarily store it in response to the second control signal CS2 at the same time the first page buffer 20_1 performs the read or write operation or after the first page buffer 20_1 starts the read or write operation.

When the read or write operation of the first page buffer 20_1 controlled by the first control signal CS1 is completed, the controller 60 may output a third control signal CS3 to control the operation of the first page buffer 20_1 and the second page buffer 20_2 in operation S40. In response to the third control signal CS3, the second page buffer 20_2 may transmit the temporarily stored data signal to the first page buffer 20_1 through one of the first through third bit lines 71 through 73 in operation S41. Upon receiving the data signal from the second page buffer 20_2, the first page buffer 20_1 may write the data signal to the first memory cell array 10_1 in accordance with the third control signal CS3 output from the controller 60 in operation S43.

According to the example embodiments, when a data signal corresponding to the first page buffer 20_1 is input while the first page buffer 20_1 is operating in response to the first control signal CS1 output from the controller 60, the data signal is temporarily stored in the second page buffer 20_2 and transmitted to the first page buffer 20_1 for future writing. As a result, the operating performance of the memory device 100 or 101 may be improved.

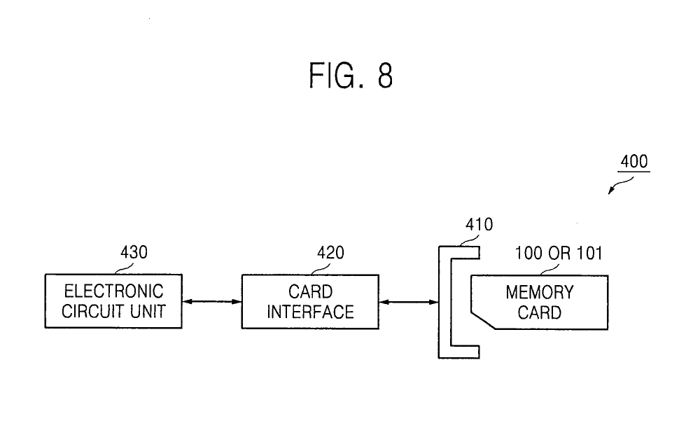

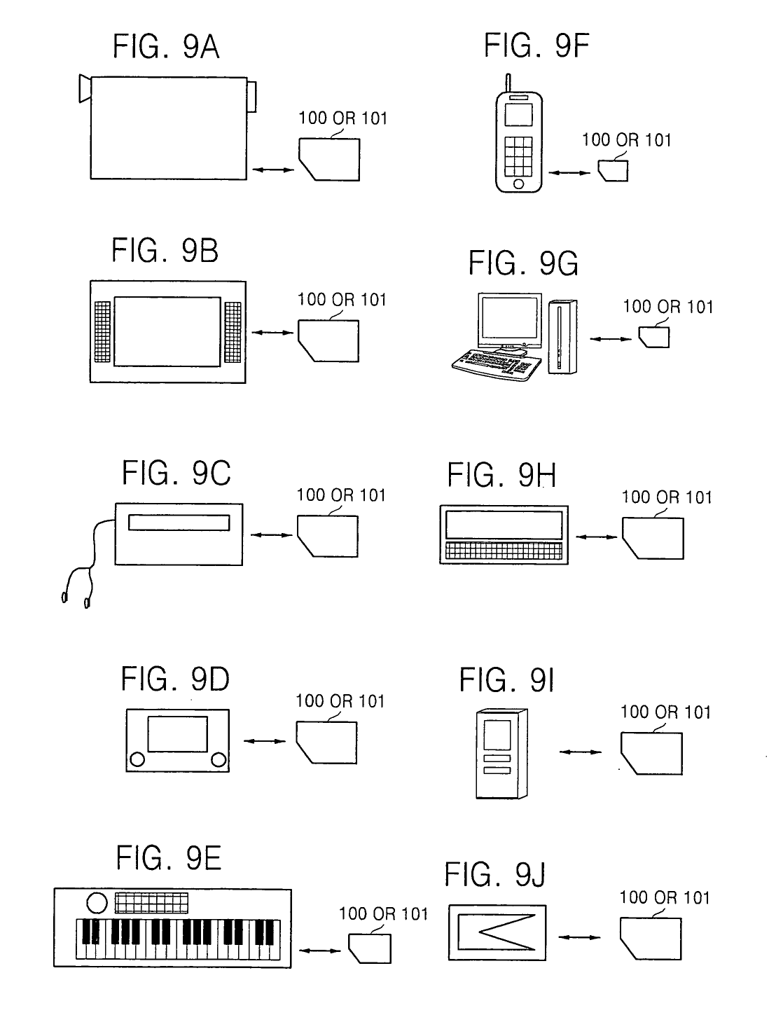

FIG. 8 is a block diagram of an electronic system including the memory device 100 or 101 having a multi-layer structure according to example embodiments. FIGS. 9A through 9J illustrate various examples of an electronic system including the memory device 100 or 101 according to example embodiments.

Referring to FIGS. 8 through 9J, the memory device 100 or 101 may be implemented by a memory card, e.g., a secure digital (SD) card, a multi-media card (MMC), or a smart card. The memory card 100 or 101 may be used in a video camera illustrated in FIG. 9A, a television (TV) or an Internet protocol TV (IPTV) illustrated in FIG. 9B, an MP3 player illustrated in FIG. 9C, an electronic game or navigator illustrated in FIG. 9D, an electronic instrument illustrated in FIG. 9E, a portable communication terminal such as a mobile phone illustrated in FIG. 9F, a personal computer (PC) illustrated in FIG. 9G, a personal digital assistant (PDA) illustrated in FIG. 9H, a voice recorder illustrated in FIG. 9I, or a PC card or a memory card reader illustrated in FIG. 9J.

When the video camera (FIG. 9A), the TV or IPTV (FIG. 9B), the MP3 player (FIG. 9C), the electronic game or navigator (FIG. 9D), the electronic instrument (FIG. 9E), the portable communication terminal (FIG. 9F), the PC (FIG. 9G), the PDA (FIG. 9H), the voice recorder (FIG. 9I), or the PC card (or the memory card reader) (FIG. 9J) includes a card interface 420 and a slot or connector 410 which may be connected with the card interface 420, the memory card 100 or 101 may be electrically connected with the slot 410 and may transmit and receive data or commands to and from a central processing unit (CPU) (or a microprocessor) (not shown) included in an electronic circuit unit 430 of the video camera, the TV or IPTV, the MP3 player, the electronic game or navigator, the electronic instrument, the portable communication terminal, the PC, the PDA, the voice recorder, or the PC card (or the memory card reader) through the card interface 420.

According to example embodiments, a memory device having a multi-layer structure is formed by stacking a semiconductor substrate including at least one page buffer on a semiconductor substrate including at least one memory cell array such that the page buffer corresponds to the memory cell array. As a result, the degree of integration of the memory cell array may be increased and the reliability of the memory device may be increased by reducing the resistance and capacitance of a bit line. In addition, since at least two page buffers may be controlled independently, at least two memory cell arrays may perform a read or write operation simultaneously. As a result, the operating performance of the memory device may be improved.

While the present invention has been particularly shown and described with reference to exemplary embodiments thereof, it will be understood by those of ordinary skill in the art that various changes in forms and details may be made therein without departing from the spirit and scope of the present invention as defined by the following claims.

What is claimed is:

1. A method of driving a memory device having a multi-layer structure, the method comprising:
operating a first page buffer in response to a first control signal output from a controller to communicate first data with a first memory cell array; and
operating a second page buffer in response to a second control signal output from the controller to communicate second data with a second memory cell array, wherein the second page buffer starts to operate and communicates the second data with the second memory cell array one of,
at the same time the first page buffer starts to operate and communicates the first data with the first memory cell array, and
after the first page buffer starts to operate.

2. The method of claim 1, wherein generating the first control signal is in response to one of a write operation, a read operation and a program operation.

3. The method of claim 1, wherein generating the second control signal is in response to one of a write operation, a read operation and a program operation.

4. The method of claim 1, further comprising:
detecting a state of a plurality of page buffers using the controller, before the operation of the first page buffer.

5. A method of driving a memory device having a multi-layer structure, the method comprising:
operating a first page buffer in response to a first control signal output from a controller to communicate first data with a first memory cell array;
operating a second page buffer in response to a second control signal output from the controller to store a second data received through a bit line, while the first page buffer is communicating the first data with the first memory cell array; and
operating the second page buffer in response to a third control signal output from the controller to transmit the second data to the first page buffer through the bit line, after the first page buffer completes communicating the first data with the first memory cell array.

6. The method of claim 5, wherein generating the first control signal is in response to one of a write operation, a read operation and a program operation.

7. The method of claim 5, wherein generating the second control signal is in response to one of a write operation, a read operation and a program operation.

8. The method of claim 5, further comprising:
detecting a state of a plurality of page buffers using the controller, before the operation of the first page buffer.

9. An electronic system comprising:
a card interface;
a slot connected with the card interface; and
a memory card connectable with the slot, wherein
the memory card includes,
a first semiconductor layer including a memory cell array, the memory cell array including a plurality of memory cells,
a second semiconductor layer stacked on the first semiconductor layer, the second semiconductor layer include a bit line and a page buffer connected to the bit line, the bit line and the page buffer correspond to the memory cell array, and
a bit line contact between the first semiconductor layer and the second semiconductor layer configured to connect the page buffer with the memory cell array.
